(19) United States
(12) Patent Application Publication
(10) Pub. No.: US 2004/0141610 A1
(43) Pub. Date: Jul. 22, 2004

(54) Telephone set

(76) Inventors: Goh Chong Ying, Singapore (SG); Tan Bock Huat, Singapore (SG); Huang Chao-Jung, Kaohsiung Shien (TW)

Correspondence Address: TROXELL LAW OFFICE PLLC, SUITE 1404, 5205 LEESBURG PIKE, FALLS CHURCH, VA, 22041, US

(21) Appl. No.: 10/345,964

(22) Filed: Jan. 17, 2003

(51) Int. Cl. H04M 1/00; H04M 9/00

(52) U.S. Cl. 379/428.01

(57) ABSTRACT

A telephone set includes a main telephone body for receiving and transmitting signals coming from a telephone company, and one or more wireless earphones wirelessly connected to the main telephone body for receiving from and transmitting signals wirelessly to the main telephone body. The wireless earphone is featured to have a plurality of input push keys for dial phone numbers for making calls via the main telephone body, portable to anywhere easily and conveniently. And a separate charger is provided for any wireless earphone placed far from the main telephone body for charging the chargeable battery in the earphone.

### BACKGROUND OF THE INVENTION

This invention relates to a telephone set, particularly to one provided with a main telephone and a wireless earphone provided with a plurality of push keys possible to dial numbers to be transmitted to the main telephone and possible to be carried on an ear or the head of a user moving around conveniently.

A common conventional telephone shown in FIGS. 1 and 2, generally has a telephone body, a receiver with a cord, and the telephone body is placed at a location stationary, inconvenient to use, as a user has to go to the location of the telephone whenever to dial a number or to get a phone call. Although a wireless telephone is very prevalent in use, a wireless receiver is rather large and always has to be charged by means of a charger on which the wireless receiver is to be placed on when it is not used. In addition, there are a few dead angles shown in FIG. 2 to interrupt communications to cause effectiveness and limited scope of receivable areas.

### SUMMARY OF THE INVENTION

This invention has been devised to offer a telephone set including a main telephone provided with an inner circuit arranging area, an exposed indicating screen for indicating the phone number dialed or received, a plurality of function push keys for setting various functions according to needs, and a separate charger for charging an earphone, one or more earphones respectively to be hung on an ear or a head of user to be wirelessly connected to the main telephone and including an inner circuit board and a receiver with a very small speaker possible to be inserted in an ear or to be closely attached to an ear. Further, each earphone is adjustable in its sound, having a plurality of input push keys for dial numbers for calling, and a separate charger provided for each earphone placed far from the main telephone body so that the earphone may not need to be charged by the main telephone body, but by the separate charger when the electricity of the chargeable battery each earphone has is used up.

### BRIEF DESCRIPTION OF DRAWINGS

This invention will be better understood by referring to the accompanying drawings, wherein:

FIG. 1 is a perspective view of a common conventional telephone set;

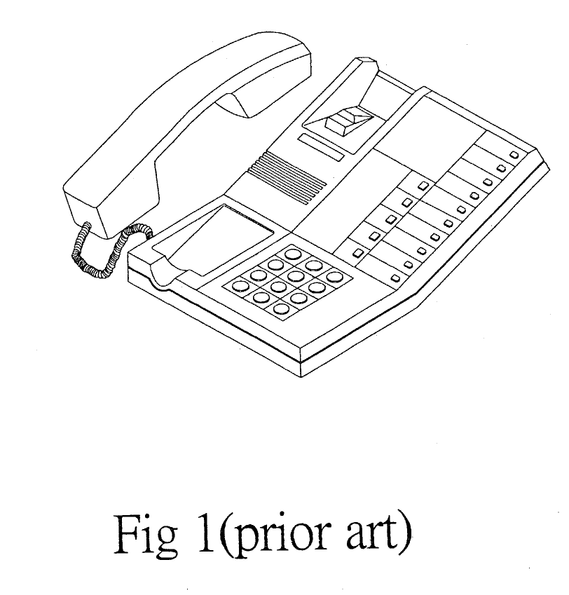

FIG. 2 is a perspective view of a common wireless telephone set;

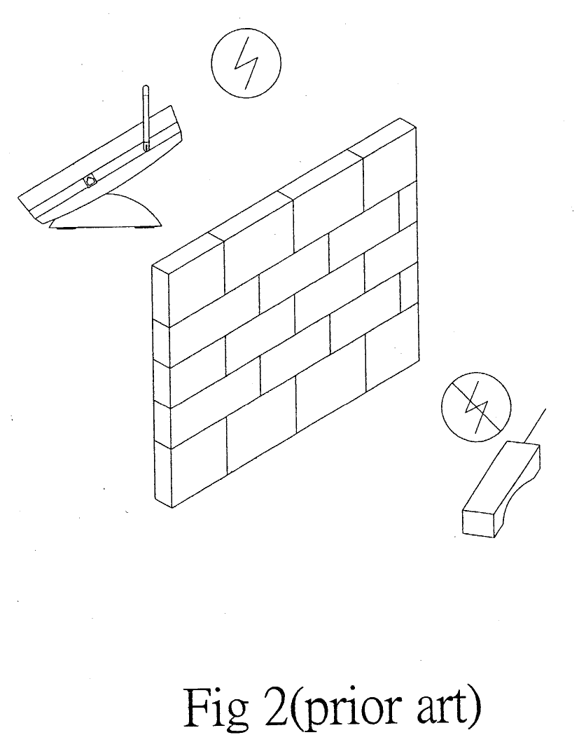

FIG. 3 is a perspective view of a main telephone of a telephone set in the present invention;

FIG. 4 is a perspective view of an earphone of a telephone set in the present invention; and,

FIG. 5 is a perspective view of a charger of a telephone set in the present invention.

### DETAILED DESCRIPTION OF THE PREFERRED EMBODIMENT

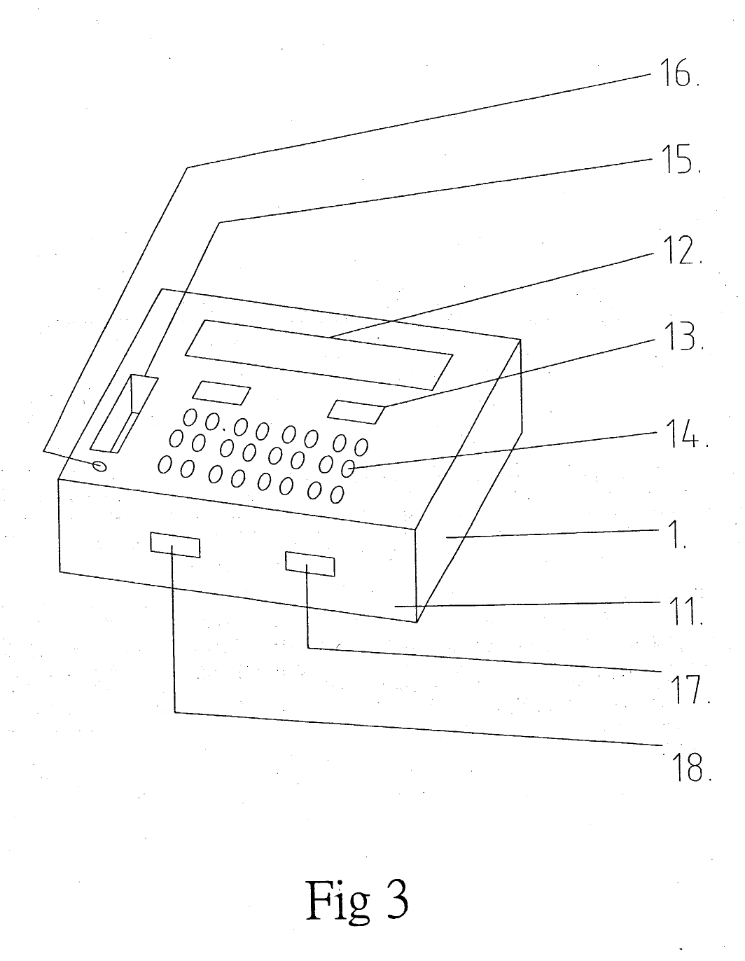

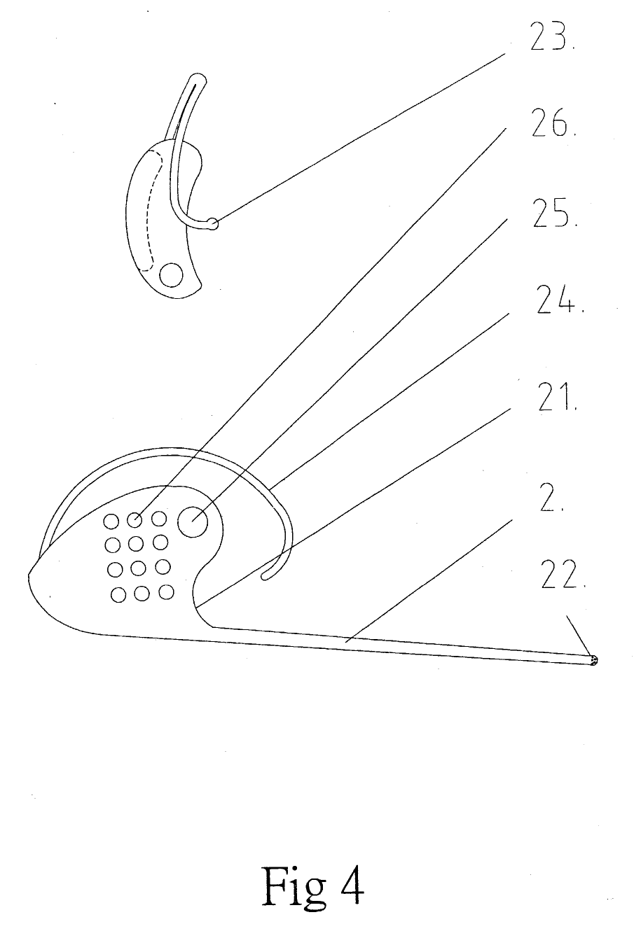

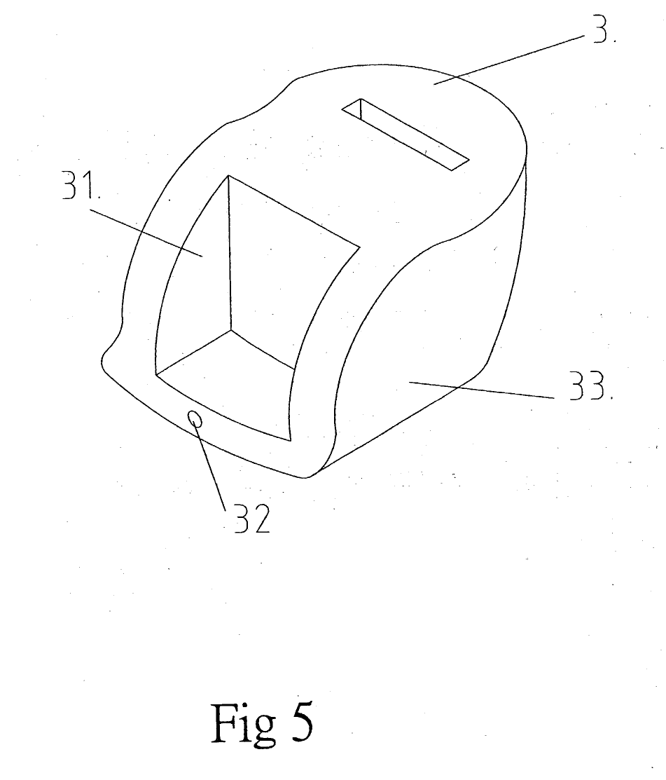

A preferred embodiment of a telephone set in the present invention, as shown in FIGS. 3, 4 and 5, includes a main telephone body 1, an earphone 2 and a charger 3 as main components combined together.

The main telephone body 1 is provided with an inner circuit board 11, an exposed indicating screen 12, a plurality of function push keys 14, a charger connecting base 15, a charge indicating lamp 16, a signal input terminal 17, and a signal output terminal 18.

The inner circuit board 11 receives and transmits signals coming outside and from one or more earphones 2. The indicating screen 12 displays the phone numbers of a call received, and information needed to be indicated, and the function push keys 14 are used by a user to set various functions, such as quick broadcast, reset, disconnect, no necessity of picking up the receiver, holding a call, message, transfer, function, broadcast, signal transfer, silence, inquiry, etc. The charger connecting base 15 is used for charging an chargeable earphone battery, and the charge lamp 16 will be lit up to indicate when the earphone battery is already charged full. The signal input terminal 17 is for connect a pin for an input, and the signal output is for connecting a pin for sending out an output.

One or more wireless earphones 2 are respectively either to be hung on an ear or the head of a user, provided with an inner circuit board 21 for receiving wireless signals coming from the main telephone body 1 and emitting wireless output signals coming from setting buttons 25 and function push keys 26, a receiving member 22 for receiving signals coming from the inner circuit board 21, a speaker 23 to be inserted in an ear for sounding out the signals coming from the receiving member 22, adjustable in its sound and preventing outer interrupting noise from coming in the ear. Further, the earphone 2 specially has a plurality of setting buttons 25 for setting various conditions and a plurality of function push keys 26 for dialing phone numbers for calling, such as the volume of sound heard, quick broadcast, reset, disconnect, hold, transfer, silence, etc.

The separate charger 3 has a small dimension, used for placing the earphone 2 thereon for charging the chargeable battery of the earphone 2. Each earphone 2 far from the main telephone body 1 has to have a separate charger 3 for charging when its chargeable battery has its electricity used up. The separate charger 3 has a charge lamp 32 for indicating the battery under charging already charged full, and a built-in signal reinforcing member 33 reinforcing signals received and emitted.

So this telephone set may has only one main telephone body 1 compatible to a plurality of wireless earphones 2 placed far from the main telephone body 1,

While the preferred embodiment of the invention has been described above and it will be recognized and understood that various modifications may be made therein and the appended claims are intended to cover all such modifications that may fall within the spirit and scope of the invention.

I claim:

1. A telephone set comprising:
A main telephone body for receiving signals coming from outside and emitting signals to outside; and having an inner circuit board for receiving signals from outside and from each wireless earphone, an exposed indicating screen for displaying the phone number received or any information needed to be displayed, a plurality of function push keys for setting conditions and dialing phone numbers for calling, a charger for changing an wireless earphone and a charge lamp for indicating the chargeable battery of the wireless earphone already charged full: and,
One or more wireless earphones connected wirelessly to said main telephone body, having a plurality of push keys for dial numbers for calling, possible to be hung on a ear or the head of a user to be carried to anywhere easily,

2. The telephone set as claimed in claim 1, wherein each said wireless earphone is to be placed on a separate charger for charging the chargeable battery each earphone has, with the specification of said separate charger conforming to that of each said wireless earphone.

3. The telephone set as claimed in claim 1, wherein each said wireless earphone is directly placed on said charger connecting base of said main telephone body for charging.

4. The telephone set as claimed in claim 1, wherein each said separate charger can independently be placed anywhere said earphone is placed far from said main telephone body.

5. The telephone set as claimed in claim 1, wherein said wireless earphone is hung on an ear of a user.

6. The telephone set as claimed in claim 1, wherein said earphone is hung on the head of a user.

7. The telephone set as claimed in claim 1, wherein said main telephone body has an input terminal.

8. The telephone set as claimed in claim 1, wherein said main telephone body has an output terminal.
